(19) United States
(12) Patent Application Publication
(10) Pub. No.: US 2007/0286795 A1
(43) Pub. Date: Dec. 13, 2007

(54) Oxygen Nanobubble Water and Method of Producing the Same

(75) Inventors: Kaneo Chiba, Miyagi (JP); Masayoshi Takahashi, Ibaraki (JP)

Correspondence Address: Robert Popa;Ladas & Parry, 5670 Wilshire Boulevard, Suite 2100, Los Angeles, CA, 90036-5679, US

(73) Assignee: MASAYOSHI TAKAHASHI, ONOGAW, TSUKUBA-CITY IBARAKI JAPAN (JP)

(21) Appl. No.: 10/591,979

(22) PCT Filed: Feb. 28, 2005
(86) PCT No.: PCT/JP05/03809

§ 371 Date: Jul. 2, 2007

(30) Foreign Application Priority Data
Mar. 8, 2004 (KR) 10-2004-0015556

(51) Int. Cl. C01B 5/00

(52) U.S. Cl. 423/580.1

(57) ABSTRACT

The present invention relates to a method of producing oxygen nanobubble water that is potentially useful in all technical fields and in particular, has evident bioactive effects upon animals and plants. Oxygen nanobubbles capable of being present in an aqueous solution for a long time, which are produced by applying physical irritation to oxygen-containing microbubbles contained in an aqueous solution, to thereby reduce the bubble diameter of the microbubble abruptly and a method for forming such oxygen nanobubbles are provided.

### TECHNICAL FIELD

The present invention relates to a method of producing oxygen nanobubble water which is potentially useful in all technical fields and has evident bioactive effects upon animals, plants and humans.

### BACKGROUND ART

Recently, it has become known that various chemical substances accumulate in the human body due to despoiling of the environment, which results in an insufficient oxygen supply at the tissue level of the living body.

In order to solve this problem, for example, Patent Reference 1 proposes microbubbles which have a nature different from ordinary bubbles and are imparted with a bioactive function by dissolving oxygen into a gas within the bubble (microbubble) having a diameter of 50 μm or less.

However, in order to enhance the bioactive function in humans, it is necessary to cause the microbubbles to operate at the tissue level. Thus, for supplying a sufficient amount of oxygen to the entire body, a large-scale system is required, which is disadvantageous from the standpoint of cost.

### DISCLOSURE OF INVENTION

The present invention has been made in view of the aforementioned circumstances and an object of the invention is to provide oxygen nanobubble water wherein oxygen is capable of being present in an aqueous solution for a long time and has an activation effect on organisms, as well as a method of producing the same.

An object of the invention is to provide oxygen nanobubble water wherein oxygen is capable of being present in an aqueous solution for a long time. The aforementioned object is achieved by an aqueous solution having oxygen nanobubbles therein containing oxygen, wherein the bubble diameter is 200 nm or less.

Furthermore, the aforementioned object of the invention is efficiently achieved by an aqueous solution having oxygen nanobubbles therein containing oxygen, wherein the bubble diameter is 200 nm or less and a salinity concentration in the range of 0.01% to 3.5%.

Furthermore, the aforementioned object of the invention is achieved by forming oxygen nanobubbles by applying a physical irritation to oxygen-containing microbubbles contained in an aqueous solution, thereby abruptly reducing the bubble diameter of the microbubble. An object of the invention is to provide a method of producing oxygen nanobubble s wherein oxygen being present in an aqueous solution for a long time. The aforementioned object is achieved more effectively by the fact that in the step of abruptly reducing microbubbles in size, when the diameter of the microbubble is reduced to 200 nm or less, the charge density on the surface of the microbubble increases and an electrostatic repulsive force is produced, whereby the size reduction of the microbubble stops; or in the step of abruptly reducing microbubbles in size, due to ions adsorbed on the gas-liquid interface and electrostatic attraction, both ions in the solution having opposite charges to each other and attracted to the vicinity of the interface are concentrated in a high concentration so as to serve as a shell surrounding the microbubble and inhibit dissolution of the gas within the microbubble into the solution whereby the microbubble is stabilized, or the ions adsorbed on the gas-liquid interface are hydrogen ions and hydroxide ions and electrolytic ions within the solution are used as the ions attracted to the vicinity of the interface whereby the microbubble is stabilized; or in the step of abruptly reducing microbubbles in size, the temperature within the microbubble sharply rises through adiabatic compression so that a physicochemical change in association with the ultrahigh temperature is applied around the microbubble whereby the microbubble is stabilized.

The aforementioned object is achieved more-effectively when the physical irritation is to discharge static electricity through the microbubbles using a discharge device; when the physical irritation is to apply ultrasonic irradiation to the microbubbles using an ultrasonic generator; when the physical irritation is to cause the solution to flow by driving a rotor mounted in a vessel containing therein the solution and use compression, expansion and vortex flow that are produced during flowing; or when the physical irritation in the case of having a circulating circuit in the vessel is to cause compression, expansion and vortex flow of the solution by passing the solution through an orifice or perforated plate having a single hole or a lot of holes after receiving the solution that contains the microbubbles.

### BRIEF DESCRIPTION OF THE DRAWINGS

FIG. 1 shows the particle size frequency distribution of oxygen nanobubbles in oxygen nanobubble water according the present invention (even distribution: about 140 nm, standard deviation: about 40 nm);

FIG. 2 is a schematic view showing a mechanism where oxygen is present in a stable state as nanobubbles within an aqueous solution;

FIG. 3 is a side view of an apparatus for producing oxygen nanobubble water using a discharge device;

FIG. 4 is a side view of an apparatus for producing oxygen nanobubble water using an ultrasonic generator;

FIG. 5 is a side view of an apparatus for producing oxygen nanobubble water by causing vortex flow; and

FIG. 6 is a side view of an apparatus for producing oxygen nanobubble water by causing vortex flow by a rotator.

### REFERENCE NUMERALS

1 vessel

2 discharge device

21 anode

22 cathode

3 microbubble generator

31 water inlet

32 oxygen nanobubbles-contained-solution outlet

4 ultrasonic generator

5 circulating pump

6 orifice plate (perforated plate)

7 rotator

### BEST MODE FOR CARRYING OUT THE INVENTION

The present invention provides an aqueous solution (oxygen nanobubble water) having therein oxygen nanobubbles containing oxygen, wherein the bubble diameter is 200 nm or less. The oxygen nanobubbles remain in the solution for a long time; as long as one or more months and have various effects.

The Oxygen nanobubble water of the invention will be described below in detail.

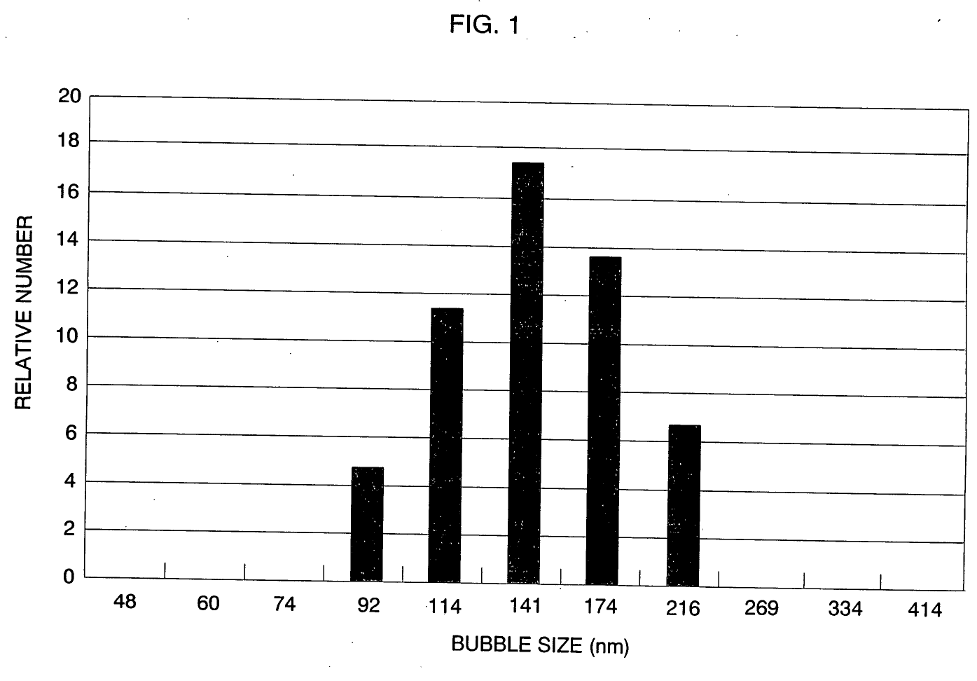

The Oxygen nanobubble water of the present invention is an aqueous solution within which the oxygen therein is maintained as nanobubbles. As seen from the bubble size distribution shown in FIG. 1, a nanobubble is a bubble having a bubble diameter of 200 nm or less. The nanobubble is characterized in that oxygen is capable of being dissolved in an aqueous solution for a long time; as long as one or more months. The preservation method of the oxygen nanobubble water is not particularly limited. Even when it is stored in an ordinary vessel, the oxygen will not vanish from the aqueous solution for one or more months.

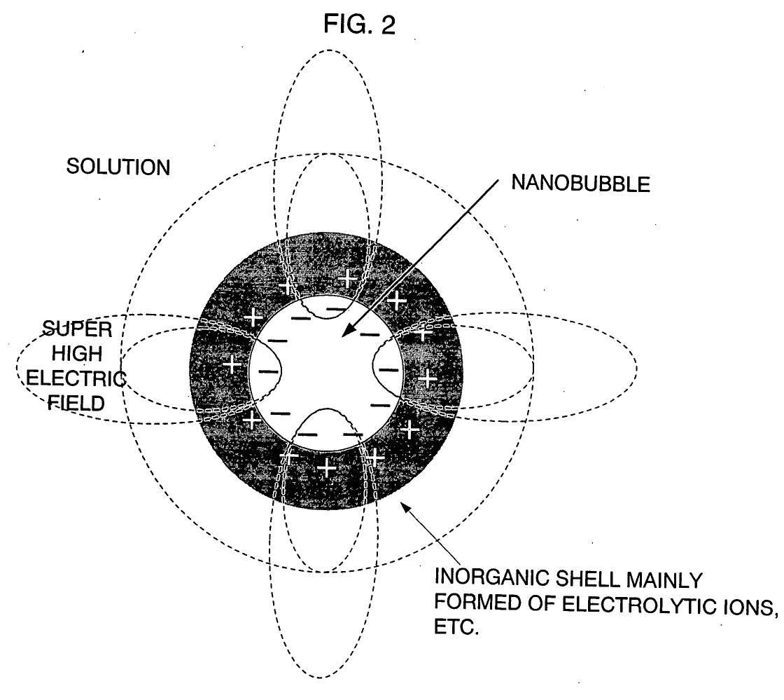

FIG. 2 shows a mechanism where oxygen in the oxygen nanobubble water of the invention is present as nanobubbles. In the case of oxygen microbubbles, the smaller the bubble, the higher the oxygen dissolution efficiency. Thus, the existence thereof becomes unstable and the bubble vanishes instantly. In the case of an oxygen nanobubble, electric charges are present on the gas-liquid interface in a significantly concentrated manner, so that the electrostatic repulsive force, which acts between the ions located in a diametrically opposed relationship to one another with respect to the sphere, inhibits the sphere (bubble) from being contracted. Furthermore, the concentrated high electric field serves to form around the bubble an inorganic shell mainly composed of the electrolytic ions, such as of iron, contained in the aqueous solution, which prevents the dissipation of the gas within the bubble. This shell is different from a surfactant shell and an organic shell. Specifically, for the shell, due to the departure of electric discharge that occurs when the oxygen nanobubble is brought into contact with other substances such as a bacterium, the shell itself collapses easily. When the shell collapses, the oxygen within the shell is easily emitted into the aqueous solution.

The endeavors of the present inventors found that by ingesting the oxygen nanobubble water of the invention in the body of living organisms, patients soon recovered from diseases and infections involving bacteria, viruses and the like could be prevented. While the reason thereof is not certain, it is expected that the oxygen nanobubbles penetrate into the body of organisms and activate their cells.

In addition, while further investigation is required to determine the reason, the present inventors found that when the salinity concentration of the oxygen nanobubble water is controlled in the range of 0.5% to 1.5%, freshwater fish and seawater fish can be kept together in a single aquarium.

According to the methods of producing oxygen nanobubble water of the present invention, oxygen microbubbles having a diameter of 10 μm to 50 μm are abruptly reduced in size by a physical irritation. When the aqueous solution therein containing oxygen microbubbles is mixed with electrolytes of ferrous ion, manganese ion, calcium ion, sodium ion, magnesium ion or any other mineral ion such that the electrical conductivity in the aqueous solution containing microbubbles therein becomes not less than 300 μS/cm, the reduction in size of the bubbles is inhibited by its electrostatic repulsive force. As used herein, the electrostatic repulsive force is an electrostatic force that causes ions having the same charge and located in a diametrically opposed relationship to one another with respect to a spherical microbubble due to increase the curvature of the sphere caused by the reduction in size of the microbubble. Since the oxygen microbubble reduced in size is subjected to pressure, the tendency to reduce in size increases with the reduction in size of the oxygen microbubble. However, when the bubble diameter becomes smaller than 200 nm, the electrostatic repulsive force becomes evident and reduction in size of the bubble stops.

When the aqueous solution is mixed with electrolytes of ferrous ion, manganese ion, calcium ion, sodium ion, magnesium ion or any other mineral ion such that the electrical conductivity in the aqueous solution becomes not less than 300 μS/cm, the electrostatic repulsive force sufficiently acts such that the force reducing the bubble in size and the electrostatic repulsive force are balanced, as a result of which the bubble is stabilized. While the diameter of the so stabilized bubble (nanobubble diameter) differs depending upon the concentration and type of the electrolytic ion, it becomes as small as 200 nm or less as shown in FIG. 1.

The characteristics of the nanobubble are not only to keep oxygen there within in a pressurized state, but also to form a significantly strong electric field by the concentrated surface electric charges. This strong electric field has exerts a great influence upon the oxygen within the bubble and the aqueous solution around the bubble, which imparts the aqueous solution with a physiological activation effect, a bactericidal effect on organisms, chemical reactivity, etc.

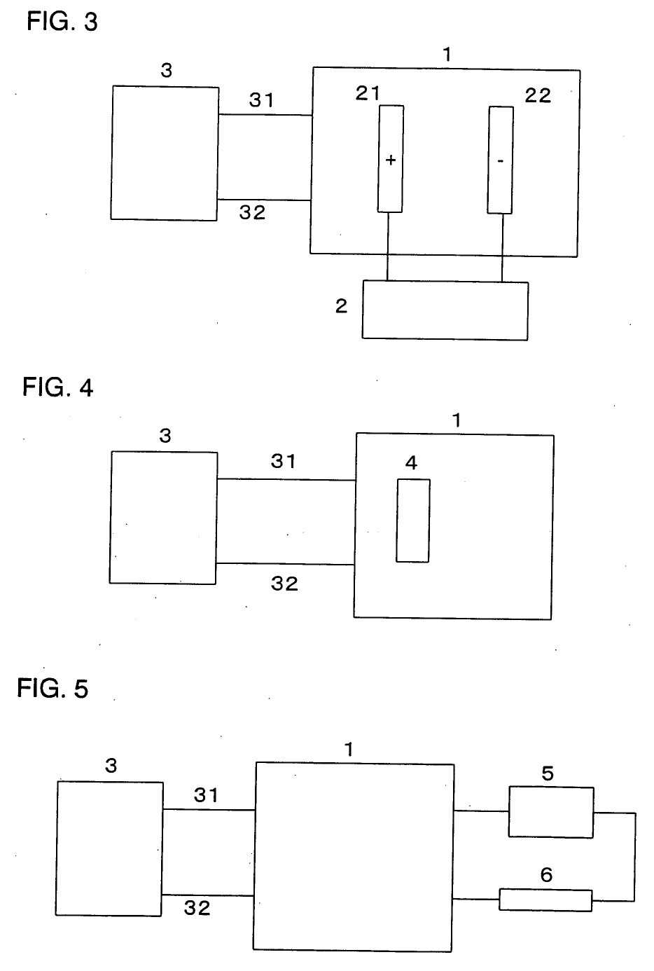

FIG. 3 is a side view of an apparatus for producing oxygen nanobubble water using a discharge device.

A microbubble generator 3 takes in an aqueous solution within a vessel 1 through a water inlet 31 and oxygen is injected through an inlet (not shown) through which oxygen for forming oxygen microbubbles within the microbubble generator 3 is injected. The oxygen is mixed with the aqueous solution from the water inlet 31 and oxygen microbubbles formed by the microbubble generator 3 are fed into the vessel 1 through an oxygen nanobubbles-containing-solution outlet 32. As a result, oxygen microbubbles become present in the vessel 1. The vessel 1 has therein an anode 21 and a cathode 22. The anode 21 and the cathode 22 are connected to a discharge device 2.

First, using the microbubble generator 3, oxygen microbubbles are generated within the vessel 1 containing therein an aqueous solution.

Then, electrolytes such as iron, manganese, calcium, or any other mineral are added to the aqueous solution such that the electrical conductivity in the aqueous solution becomes not less than 300 μS/cm.

Using the discharge device 2, the aqueous solution containing oxygen microbubbles therein within the vessel 1 is subjected to aqueous discharging. In order to form oxygen nanobubbles more efficiently, it is preferable that the concentration of the oxygen microbubbles within the vessel 1 has reached 50% or more of the saturated concentration. Furthermore, the voltage of the aqueous discharging is preferably in the range of 2000 V to 3000 V. The shock wave stimulus (physical irritation) associated with the aqueous discharging reduces the oxygen microbubbles abruptly in size within the water, by which nano-level bubbles are formed. The ions existing around the bubble at this time are abruptly concentrated with the reduction in size of the bubble because the bubble reduction speed is high and there is no time for such ions to dissolve into the surrounding water. The concentrated ions produce a significantly high electric field around the bubble. Under the existence of this high electric field, hydrogen ions and hydroxide ions at the gas-liquid interface have a bonding relationship with the electrolytic ions having the opposite charge thereto and located near the bubble, thereby forming an inorganic shell around the bubble. This shell inhibits spontaneous dissolution of the oxygen within the bubbles into the aqueous solution, so that the oxygen nanobubbles can be stably contained in the aqueous solution without dissolving. Furthermore, the formed oxygen nanobubble is a very tiny bubble having a diameter of about 200 nm or less, so that it does not experience buoyant force and rupture near the water surface, which is observed for normal bubbles.

A method of producing oxygen nanobubble water by applying ultrasound as a physical irritation to oxygen microbubbles will be described below. The same description as above is not repeated.

FIG. 4 is a side view of an apparatus for producing oxygen nanobubble water using an ultrasonic generator.

Similar to the method of producing oxygen nanobubble water by means of discharging, oxygen microbubbles are formed at a microbubble generator 3, a water inlet 31 and an oxygen nanobubbles-contained-solution outlet 32 and the oxygen microbubbles are fed into the vessel 1. The vessel 1 has an ultrasonic generator 4 mounted therein. The mounting position of the ultrasonic generator 4 is not particularly limited. However, in order to efficiently form oxygen nanobubbles, it is preferable to dispose the ultrasonic generator 4 between the water inlet 31 and the oxygen nanobubbles-contained-solution outlet 32.

First, using the microbubble generator 3, oxygen microbubbles are generated within the vessel 1 having therein water containing electrolytic ions.

Then, using the ultrasonic generator 4, ultrasound is applied to the oxygen-microbubbles-contained aqueous solution within the vessel 1. In order to form oxygen nanobubbles more efficiently, it is preferable that the concentration of the oxygen microbubbles within the vessel 1 has reached 50% or more of the saturated concentration. Preferably, the oscillating frequency of the ultrasonic waves is 20 kHz to 1 MHz and the oscillation and intermission of the application of the ultrasonic waves are carried out alternately at intervals of 30 seconds. However, the ultrasonic waves may be applied continuously.

A method of producing oxygen nanobubble water by producing a vortex flow as a physical irritation will be described below. The same description as above is not repeated.

FIG. 5 is a side view of an apparatus using compression, expansion and vortex flow in order to produce oxygen nanobubble water. Similar to the method of producing oxygen nanobubble water by means of discharging and ultrasonic application, microbubbles are formed at a microbubble generator 3, a water inlet 31 and an oxygen nanobubbles-contained-solution outlet 32 and the microbubbles are fed into the vessel 1. A circulating pump 5 for regionally circulating the oxygen-microbubbles-contained aqueous solution within the vessel 1 is connected to the vessel 1. An orifice plate (perforated plate) 6 having many holes is disposed within the piping (circulation piping) in which the circulating pump is provided. The orifice plate 6 is also connected with the vessel 1. The circulating pump 5 causes the oxygen-microbubbles-contained aqueous solution within the vessel 1 to flow in the circulation piping and pass through the orifice plate (perforated plate) 6, which causes compression, expansion and vortex flow.

First, using the microbubble generator 3, oxygen microbubbles are generated within the vessel 1 having therein water containing electrolytic ions.

Then, the circulating pump 5 is operated for regionally circulating the oxygen-microbubbles-contained aqueous solution. The circulating pump 5 forces out the oxygen-microbubbles-contained aqueous solution, which causes compression, expansion and vortex flow within the piping before and after passing through the orifice plate (perforated plate) 6. By the fact that the oxygen microbubbles are compressed or expanded when they are passed through the orifice plate and the oxygen microbubbles electrically-charged by the vortex flow produced within the piping causes an eddy-current, the oxygen microbubbles are abruptly reduced in size and stabilized as nanobubbles. The circulating pump 5 and the orifice plate (perforated plate) 6 may be arranged in the inverse order in the passage.

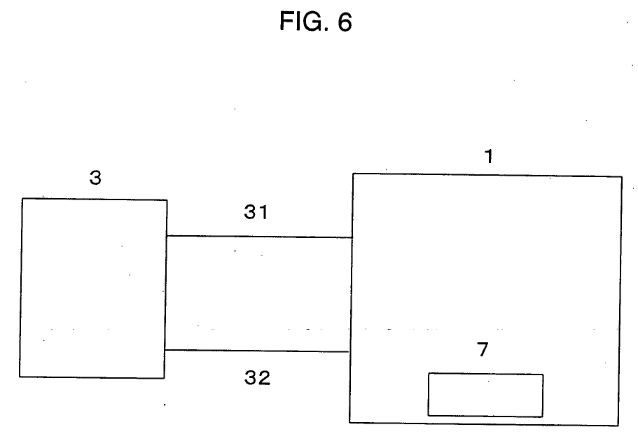

While a single orifice plate (perforated plate) 6 is provided in FIG. 6, a plurality of orifice plates may be provided. Furthermore, the circulating pump 5 may be omitted as is appropriate. In this case, it is also possible to use the driving force of the microbubble generator 2 with respect to the aqueous solution or flowing the aqueous solution due to a difference of elevation.

Furthermore, as shown in FIG. 6, nanobubbles may be formed by mounting in the vessel 1 a rotator 7 for producing vortex flow. Rotating the rotator 7 at 500 to 10000 rpm can efficiently produce vortex flow within the vessel 1.

A detailed description of the tests on the features and effects of the oxygen nanobubble water of the invention will be given below, but the invention is not limited thereto.

### EXAMPLE 1

After producing oxygen nanobubble water of the invention, the nanobubbles were measured by bubble size distribution with a peak of about 150 nm. The oxygen nanobubble water was placed in a glass bottle and stored in a cool, dark place. When a similar measurement was performed thereon after one month, the oxygen nanobubble water had substantially the same bubble size distribution and was maintained in a stable state.

The action of the electrolytic ions is important for stabilizing nanobubbles in the oxygen nanobubble water. The water quality of the oxygen nanobubble water of the invention was measured to be pH=8.4, hardness=1000 mg/L, iron<0.03 mg/L, manganese=0.016 mg/L, sodium=2200 mg/L and chloride ion=2110 mg/L.

### EXAMPLE 2

Weakened sardines and black rockfish were placed in oxygen nanobubble water having a salinity concentration between that of freshwater and seawater. They soon recuperated.

Furthermore, when the oxygen nanobubble water was placed in a single aquarium, sea fish such as sea bream, flounder, plaice, greenling, beauty gobies, dark sleepers, etc. and freshwater fish such as mirror carp, goldfish, tetsugyo, sweetfish, mountain trout, etc., were able to survive for over a 6 month period or longer in a single aquarium. Furthermore, in this period, rapid growth of young fish was observed. In addition, for tropical fish, sea fish such as cobalt fish and freshwater fish such as guppies could survive in a single aquarium for several days even in water temperatures of about 15° C.

### EXAMPLE 3

At fowl breeding site, the oxygen nanobubble water produced according to Example 1 was given to the fowls to drink. Their resistance to infection increased, as a result of which the amount of antibiotics they were given was significantly reduced.

### ADVANTAGEOUS EFFECTS OF THE INVENTION

According to the oxygen nanobubble water and the method of producing the same of the present invention, oxygen is contained in the oxygen nanobubble water as nanobubbles having a diameter of 200 nm or less and it becomes possible to keep the oxygen dissolved in the aqueous solution for a long time; as long as one or more months. Thus, it becomes possible to use the oxygen nanobubble water for the purpose of enhancing bioactivity effects through oxygen in medical applications, fish husbandry applications, fish farming applications, as well as in livestock husbandry applications.

Furthermore, by ingesting the oxygen nanobubble water of the invention into living organisms, patients quickly recover from diseases and infections involving bacteria, viruses and the like can be prevented. Furthermore, by applying the oxygen nanobubble water of the invention to the skin, it becomes possible to promote recovery from skin disease.

In addition, by controlling the salinity concentration of the oxygen nanobubble water in the range of 0.5% to 1.5%, it becomes possible to keep freshwater fish and seawater fish together in a single aquarium. Furthermore, by placing weakened fish in the oxygen nanobubble water controlled to have a salinity concentration in the range of 0.5% to 1.5%, it becomes possible to recuperate weakened fish.

### INDUSTRIAL APPLICABILITY

For the oxygen nanobubble water of the invention and the oxygen nanobubble water obtained by the method of producing the same, oxygen is capable of being dissolved in the aqueous solution for a long time; as long as one or more months. Thus, the invention would be applicable in medical applications, fish husbandry applications, fish farming applications, as well as in livestock husbandry applications, wherever enhancing bioactivity effects through oxygen is required.

Furthermore, since patients quickly recover from diseases and infections involving bacteria, viruses and the like can be prevented by ingesting the oxygen nanobubble water of the present invention into living organisms, the invention would be applicable in the medical field or the like, where the prevention of infections is necessary.

Since it becomes possible to keep freshwater fish and seawater fish together in a single aquarium by controlling the salinity concentration of the oxygen nanobubble water in the range of 0.5% to 1.5%, the invention would be applicable in the aquaculture industry, the marine products industry and the like.

Furthermore, when weakened fish are placed in the oxygen nanobubble water controlled to have a salinity concentration in the range of 0.5% to 1.5%, the weakened fish recuperate, so that the invention would be applicable in the aquaculture industry, the marine products industry and the like.

### LIST OF REFERENCES

Patent Reference 1: Japanese Unexamined Patent Publication No. 2002-143885

1. Oxygen nanobubble water, which is an aqueous solution having oxygen nanobubbles therein containing oxygen, wherein the bubble diameter thereof is 200 nm or less.

2. Oxygen nanobubble water which is an aqueous solution having oxygen nanobubbles therein containing oxygen, wherein the bubble diameter thereof is 200 nm or less and the salinity concentration of the aqueous solution is set in the range of 0.01% to 3.5%.

3. A method of producing oxygen nanobubble water, wherein oxygen nanobubbles are formed by applying physical irritation to oxygen-containing microbubbles contained in an aqueous solution, to thereby reduce the bubble diameter of the microbubble abruptly.

4. The method of producing oxygen nanobubble water according to claim 3, wherein in the step of abruptly reducing the microbubbles in size, when the diameter of the microbubble is reduced to 200 nm or less, a charge density on the surface of the microbubble increases and an electrostatic repulsive force is produced, whereby the size reduction of the microbubble stops.

5. The method of producing oxygen nanobubble water according to claim 3, wherein in the step of abruptly reducing microbubbles in size, due to ions adsorbed on a gas-liquid interface and an electrostatic attraction, both ions in the aqueous solution having opposite charges to each other and attracted to the vicinity of the interface are concentrated in a high concentration so as to serve as a shell surrounding the microbubble and inhibit the dissolution of oxygen within the microbubble into the aqueous solution, whereby the oxygen nanobubble is stabilized.

6. The method of producing oxygen nanobubble water according to claim 3, wherein the ions adsorbed on a gas-liquid interface are hydrogen ions and hydroxide ions and electrolytic ions within the aqueous solution are used as the ions attracted to the vicinity of the interface, whereby the oxygen nanobubble is stabilized.

7. The method of producing oxygen nanobubble water according to claim 3, wherein in the step of abruptly reducing microbubbles in size, the temperature within the microbubble sharply rises by adiabatic compression so that a physicochemical change in association with the ultrahigh temperature is applied around the microbubble, whereby the oxygen nanobubble is stabilized.

8. The method of producing oxygen nanobubble water according to claim 3, wherein the physical irritation is to discharge static electricity through the microbubbles using a discharge device.

9. The method of producing oxygen nanobubble water according to claim 3, wherein the physical irritation is to apply ultrasonic irradiation to the microbubbles using an ultrasonic generator.

10. The method of producing oxygen nanobubble water according to claim 3, wherein the physical irritation is to cause the aqueous solution to flow by driving a rotor mounted in a vessel containing therein the aqueous solution and use compression, expansion and vortex flow which are produced during the flowing.

11. The method of producing oxygen nanobubble water according to claim 3, wherein in the case of having a circulating circuit in the vessel, the physical irritation is to cause compression, expansion and vortex flow of the aqueous solution by passing the solution through an orifice or perforated plate having a single hole many holes after receiving the aqueous solution in which the microbubbles are contained.
